(19) United States
(12) Patent Application Publication
(10) Pub. No.: US 2026/0038357 A1
(43) Pub. Date: Feb. 5, 2026

(54) INTEROPERABILITY APPARATUS AND METHODS FOR A CLOUD-BASED EMERGENCY DATA MANAGEMENT SYSTEM

(71) Applicant: RAPIDSOS, INC., New York, NY (US)

(72) Inventor: John Robert Katt, New York, NY (US)

(21) Appl. No.: 19/290,096

(22) Filed: Aug. 4, 2025

Related U.S. Application Data
(60) Provisional application No. 63/679,095, filed on Aug. 3, 2024.

(51) Int. Cl. G08B 25/00; H04L 67/10

(52) U.S. Cl. CPC G08B 25/007; H04L 67/10

(57) ABSTRACT

A method implements; obtaining emergency call data from one or more functional elements of an emergency communication center (ECC) by an interoperability apparatus; sending the emergency data from the interoperability apparatus to a cloud-based emergency data management system; converting a portion of the emergency data into a data object at the cloud-based emergency data management system; providing the data object to an instance of a cloud-based application provided by the cloud-based emergency data management system, where the instance is executed using a browser on a computer located at the ECC, and the data object updates a map view within a graphical user interface provided by the instance; and providing update data from the cloud-based emergency data management system to a computer-aided-dispatch system using the interoperability apparatus. The emergency data includes: ANI/ALI (Automatic Number Identification/Automatic Location Identification) data, call detail record (CDR) data, AVL (Automatic Vehicle Location) data, and voice data.

### CROSS-REFERENCE TO RELATED APPLICATIONS

The present application claims priority to U.S. Provisional Patent Application No. 63/679,095, filed Aug. 3, 2024, entitled “INTEROPERABILITY APPARATUS AND METHODS FOR A CLOUD-BASED EMERGENCY DATA MANAGEMENT SYSTEM” which is hereby incorporated by reference herein in its entirety, and which is assigned to the same assignee as the present application.

### FIELD OF THE DISCLOSURE

The present disclosure relates generally to enhanced 9-1-1 (E911) and next generation 9-1-1 (NG911) emergency networks and more particularly to methods, apparatuses, and systems used in responding to emergencies.

### BACKGROUND

The evolution of emergency networks toward achieving full enhanced 9-1-1 (E911) and next generation 9-1-1 (NG911) capabilities has been arduous. Currently, most emergency networks remain a conglomeration of legacy 9-1-1 telecommunications equipment and added in components to begin creating full enhanced and next generation capabilities.

Emergency networks involve an Emergency Communication Center (ECC) which is defined by the National Emergency Number Association (NENA) as “A set of call takers operating under common management which receives emergency calls for service and asynchronous event notifications and processes those calls and events according to a specified operational policy.” A specific type of ECC is a Public Safety Answering Point (PSAP) which NENA defines as an entity responsible for receiving 9-1-1 calls and processing those calls according to a specific operational policy.

ECC call takers benefit from various software systems including call handling and call taking software, computer-aided-dispatch (CAD) systems and the like. As ECCs evolve toward advanced capabilities, new requirements for data flow in and out of the ECCs has also become a consideration.

### BRIEF DESCRIPTION OF THE DRAWINGS

FIG. 1 is a block diagram of an Emergency Communication Center (ECC) in communication with a cloud-based emergency data management system (EDMS) and that includes an interoperability apparatus, in accordance with an embodiment. The ECC may be a Public Safety Answering Point (PSAP).

FIG. 2 is a block diagram of an example interoperability apparatus in accordance with an embodiment.

FIG. 3 is a block diagram of an example interoperability apparatus in communication with a cloud-based emergency data management system (EDMS) and providing data layers, logging and analytics data, and incident creation and updates in accordance with an embodiment.

FIG. 4 is a diagram of example graphical user interfaces (GUIs) provided to a computer system of a Public Safety Answering Point (PSAP), and to a computer-aided-dispatch (CAD) system of the PSAP in accordance with an embodiment.

FIG. 5 is a diagram showing further details of an emergency data management system in accordance with various embodiments.

FIG. 6 is a flowchart of a method of operation of an interoperability apparatus in accordance with an embodiment.

FIG. 7 is a flowchart of a method of operation of an EDMS in accordance with an embodiment.

FIG. 8 is a flowchart of a method of operation of an interoperability apparatus and EDMS in accordance with an embodiment.

FIG. 9 is a flowchart of a method of operation of an interoperability apparatus and EDMS in accordance with an embodiment.

FIG. 10 is a flowchart of a method of operation of an interoperability apparatus and EDMS in accordance with an embodiment.

FIG. 11 is a flowchart of a method of operation of an interoperability apparatus and EDMS in accordance with an embodiment.

### DETAILED DESCRIPTION

Briefly, the present disclosure provides an interoperability apparatus in conjunction with a cloud-based emergency data management system that provides, among other things, a capability of the cloud-based emergency data management system to communicate with various disparate systems within an emergency communications center (ECC). One example ECC is a public safety access point (PSAP) that receives and responds to 9-1-1 emergency calls, and dispatches responders such as, but not limited to, police, fire department, and paramedics. The disclosed apparatus, systems, and methods enable enhancements to emergency mapping, dispatch location identification and pinpointing accuracy, computer-aided-dispatch (CAD) incident creation, data logging and analytics, and aid in reduction of emergency response times thereby.

In one aspect, a method implements: A method implements; obtaining emergency call data from one or more functional elements of an emergency communication center (ECC) by an interoperability apparatus; sending the emergency data from the interoperability apparatus to a cloud-based emergency data management system; converting a portion of the emergency data into a data object at the cloud-based emergency data management system; providing the data object to an instance of a cloud-based application provided by the cloud-based emergency data management system, where the instance is executed using a browser on a computer located at the ECC, and the data object updates a map view within a graphical user interface provided by the instance; and providing update data from the cloud-based emergency data management system to a computer-aided-dispatch system using the interoperability apparatus. The emergency data includes: ANI/ALI (Automatic Number Identification/Automatic Location Identification) data, call detail record (CDR) data, AVL (Automatic Vehicle Location) data, and voice data.

A disclosed system includes: an interoperability apparatus that has at least one processor and a non-volatile, non-transitory memory, operatively coupled to the at least one processor. The interoperability apparatus is located at an emergency communication center (ECC), and is operatively coupled to an ECC functional element, and also to a cloud-based emergency data management system. The emergency data management system includes at least one cloud server and operatively coupled non-volatile, non-transitory memory. The interoperability apparatus is operative to receive emergency call data from a plurality of ECC functional elements and from an ECC computer-aided-dispatch (CAD) system. The cloud-based emergency data management system operative to: receive the emergency call data from the interoperability apparatus; convert the emergency call data into a data object; send the data object to an instance of a cloud-based application executed by a computer located at the ECC; and update a map view of the instance of the cloud-based application using the data object. The data types handled includes ANI/ALI (Automatic Number Identification/Automatic Location Identification) data, call detail record (CDR) data, and AVL (Automatic Vehicle Location) data, call handling data, and voice data.

Another disclosed method implements: obtaining voice data related to an emergency call to an emergency communication center (ECC) by an interoperability apparatus operatively coupled to a functional element of the ECC; sending the voice data from the interoperability apparatus to a cloud-based emergency data management system; performing keyword analysis of the voice data by the cloud-based emergency data management system; and providing a data object to an instance of a cloud-based application provided by the cloud-based emergency data management system, the instance executed using a browser on a computer located at the ECC, the data object updating a map view within a graphical user interface provided by the instance with additional data in response to the keyword analysis.

Another disclosed method implements: obtaining voice data related to an emergency call to an emergency communication center (ECC) by an interoperability apparatus operatively coupled to a functional element of the ECC; sending the voice data from the interoperability apparatus to a cloud-based emergency data management system; performing keyword analysis of the voice data by the cloud-based emergency data management system; providing update data from the cloud-based emergency data management system to a computer-aided-dispatch (CAD) system using the interoperability apparatus, in response to the keyword analysis. The method may further implement updating a CAD incident form in response to the keyword analysis.

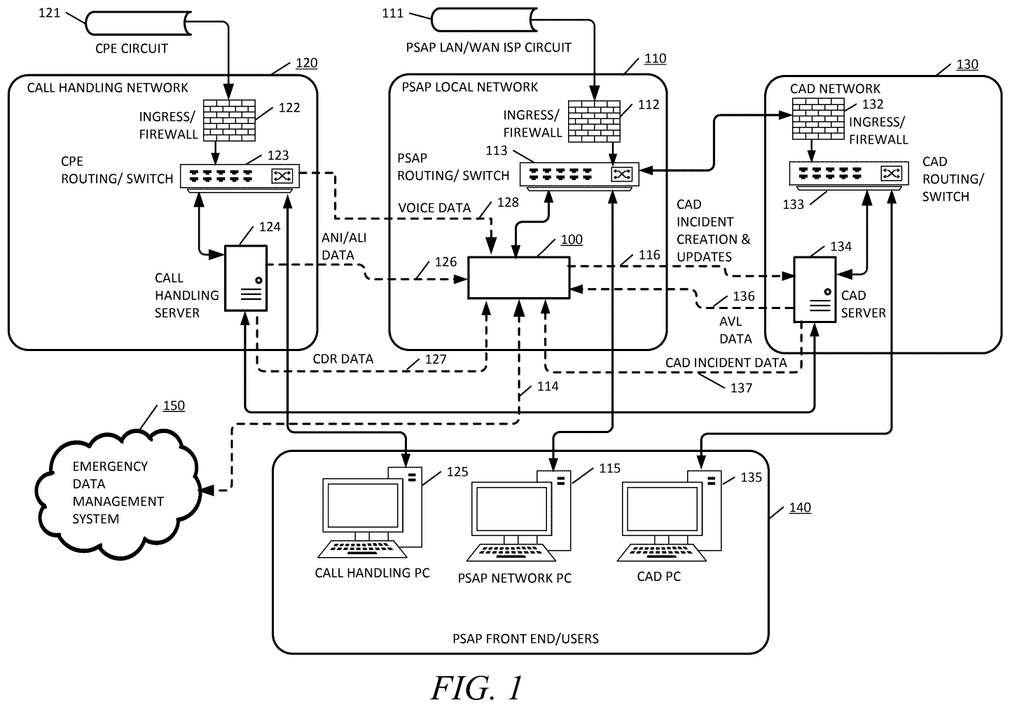

Turning now to the drawings wherein like numerals represent like components, FIG. 1 is a block diagram of an Emergency Communication Center (ECC) that is in communication with a cloud-based emergency data management system (EDMS 150) that includes an interoperability apparatus 100, in accordance with various embodiments. The ECC may be a Public Safety Answering Point (PSAP). The EDMS 150 provides one or more software-as-a-service (SaaS) applications to the ECC. The ECC includes Customer Premises Equipment (CPE) which is a set of communications or terminal equipment located in the ECC or PSAP facilities. In telecommunications, the acronym “CPE” may be defined as “customer-premises equipment” or “customer-provided equipment” and refers to any terminal and associated equipment located at a telephone system subscriber's premises and connected with a telephone carrier's telecommunication circuits at a demarcation point. The demarcation point established in a building or complex, or some specific location, separates the specific customer equipment (i.e. the ECC or PSAP equipment) from other equipment located in either the distribution infrastructure or central office of the communications service provider (such as a telephone carrier).

Examples of equipment that may be included in a CPE may include, but are not limited to, active equipment and devices such as telephones, routers, network switches, gateways, networking adapters and Internet access gateways that enable the ECC to access communication services and distribute them within an ECC local area network (LAN); or passive equipment such as analogue telephone adapters (ATA) or xDSL-splitters, including various telephone systems, private branch exchanges (PBXs) etc. Some of this equipment may be devices purchased by the ECC, however some may be provided by one or more service providers that provide telecommunications or other services to the ECC. The ECC CPE may have one or more racks or chassis to encase and hold the CPE equipment and to enable cabling and interconnection via various CPE-peripherals.

One specific example equipment in an ECC CPE is an Automatic Number Identification Controller (ANI Controller) which is defined by NENA as a “stand-alone CPE component which provides the ANI decoding and function key control for 9-1-1 service.” The ANI (Automatic Number Identification) refers to a telephone number (i.e. a “caller ID”) associated with the access line from which a call originates, and in legacy trunked telephony lines is transmitted to an ECC on a sideband channel transmitted on a trunked line. Assuming the system is operating properly, the ECC receives an ANI number associated with a 9-1-1 emergency call as it arrives.

Procedurally, an ECC then sends an “ALI Request” which is defined by NENA as a “query for an ALI record sent from the PSAP to the ALI database.” The ECC or PSAP may also perform “ALI Retrieval” which NENA defines as “the process by which a PSAP queries an ALI database with an ALI Request and receives a response with location and other available information.” The term “ALI” (Automatic Location Identification) is defined by NENA as “the automatic display at the PSAP of the caller's telephone number, the address/location of the telephone and supplementary emergency services information of the location from which a call originates.” The ANI and ALI data collectively may be referred to a “ANI/ALI” data (i.e. “ANI” Automatic Number Identification and “ALI” Automatic Location Identification). The ECC “ANI/ALI system” per the NENA standard, NENA E9-1-1 PSAP Equipment Standards, NENA-STA-027.3-2018 (Jul. 2, 2018), requires that ANI data as received is displayed to the telecommunicator.

The ECC “ANI/ALI system” per the NENA standard, NENA E9-1-1 PSAP Equipment Standards, NENA-STA-027.3-2018 (Jul. 2, 2018), is also required to be “equipped with an interface that is capable of providing a CDR (Call Detail Record) output to an optional compatible device,” and desirably “has the ability to store CDR records to a data file that can be downloaded onto recordable media on demand.” The NENA definition of a CDR (Call Detail Record) is “a record stored in a database recording the details of a received or transmitted call.” The NENA standard further requires that a CDR includes: trunk seize time, caller's telephone number, answer time, answering position number, trunk number, trunk release time, time call was transferred, PSAP name or number that the call was transferred to, abandoned call indicator, and date. Although a date does not have to be included in each record, the date must at least be included once per page of records. In addition to the above listed CDR requirements, a CDR may also include: ringing start time, time call was placed on hold, time call was taken off of hold and by what position number, and ALI data. The physical interface for CDR output may be RS-232-C, parallel, network, or USB according to the NENA standard.

Another specific example equipment in an ECC which may have one or more connections to the ECC CPE is a Computer Aided Dispatch (CAD) system. Nena defines CAD as “A computer based system, which aids PSAP Telecommunicators by automating selected dispatching and record keeping activities.” CAD systems are used to respond to a call for service (CFS) (also referred to as an “emergency call”) by creating a corresponding “incident” record, and dispatchers use the CAD system information to dispatch emergency responders to the incident address. A definition of the term “incident” is provided by APCO International. The Association of Public-Safety Communications Officials (APCO) International is the world's oldest and largest organization of public safety communications professionals, and generates standards related to public safety. One example APCO International standard is “Public Safety Communications Common Incident Types For Data Exchange,” APCO 2.103.2-2019. This standard defines the term “incident” as a “real world event such as a motor vehicle accident, structure fire or illness.” “Incidents may be declared by an ECC or by a unit reporting from the field.” Regarding CAD systems, the standard also defines an “incident type code” as “an acronym or other abbreviated combination of alphanumeric characters used to describe the nature of the real-world event that is being reported.” “Incident type codes typically differ between disparate ECCs and public safety agencies.”

CAD system operators are often referred to as “dispatchers” who operate a CAD workstation to dispatch emergency responders to the location of an emergency and manage vehicles and personnel. Depending on the size of an ECC, personnel may work as both call takers and dispatchers. In that situation an ECC operator may serve as a call taker and as a dispatcher and may have access to call taking software as well as CAD software. In larger metro areas, call taking is a separate function from dispatcher and when a call taker receives a CFS (i.e. emergency call) the call taker will communicate verbally with a dispatcher to convey information related to the emergency call. The dispatcher may then access the CAD software to create an incident and populate a specialized form selected to correspond the incident based on an incident type code as described in the APCO International standard discussed above.

This is a manual process and may be prone to errors in data entry by either the call taker/dispatcher or by a dispatcher receiving information verbally from a call taker. Additionally, each ECC may use its own incident forms and may require unique incident information specific for the particular ECC. CAD incident records may include hundreds of lines of textual information that includes some information manually entered by personnel, and some information populated from the call handling system such as the ANI/ALI data. The CAD system uses various types of data for various purposes. Each CAD incident form, that corresponds to an incident type having an incident type code as described in the APCO International standard discussed above, may include unique data specific to the incident type. For example, an “industrial accident” (incident code “ACCIND”) may have data related to an involved factory, machinery, hazardous materials involved or other related information. A medical emergency such as a “cardiac related event” (incident code CARDIA) may have medical data related to the specific patient. Each incident code will have specific data related to that specific incident.

Another example of CAD system data is AVL data. CAD systems generally provide operators with a view to AVL data, (Automatic Vehicle Location data), and NENA defines AVL as “A means for determining the geographic location of a vehicle and transmitting this information to a point where it can be used.” More particularly, AVL data is information that is used the CAD system operators to track the location of vehicles, such as police cars, fire department vehicles, and ambulances, etc., in real-time.

AVL data may be generated by a Global Positioning System (GPS) or other location tracking systems that are installed within emergency responder vehicles. The AVL data may include, for example, a current location of a vehicle, as well as information about its speed, direction, and other information. A CAD workstation may display a map with layers of AVL data, among other layers, that therefore can be used to track the location and status of emergency responder vehicles in real-time, to provide dispatchers with information about the availability and location of resources, and to quickly see the location and status of all vehicles in the fleet. ECC dispatchers can thus use AVL information to make informed decisions about how to best deploy vehicles and personnel in response to emergency calls, alarms, etc. Reports and analytics may also be generated using AVL data, which can be used to improve the ECC operating efficiency and effectiveness, among other uses.

The ECC may obtain AVL data via a variety of networks, and emergency responder vehicles may for example, have an AVL system that is connected to a wireless modem or other device that is operative to transmit the data to the ECC over a wireless network. The wireless networks employed may be, but are not limited to: cellular networks including 5G networks, satellite networks, Wi-Fi networks, or ECC propriety wireless networks, etc. Intake of the AVL data by the ECC may then be through equipment located within the ECC CPE that is connected to the ECC local area network (LAN).

The ECC includes “call handling” which NENA defines as “a functional element concerned with the details of the management of calls.” According to NENA, call handling handles all communication from the caller and includes the interfaces, devices and applications utilized to handle the call. A “functional element” or “functional entity” is defined by NENA as “a set of software features that may be combined with hardware interfaces and operations on those interfaces to accomplish a defined task.” The ECC includes an APU (Answering Position Unit) which is defined by NENA as “a term used to define call-taking equipment.” The call handling PC 125 (or call handling workstation) shown in FIG. 1 may be referred to as an APU and is operatively coupled to a CPE circuit 121 via a call handling server 124 and a CPE router/switch 123. The call handling network 120 includes an ingress firewall 122 coupled to the CPE circuit 121 which provides telephone network access to the ECC. The CPE routing/switch 123 is operatively coupled to the ingress/firewall 122.

A PSAP local network 110 also includes a PSAP routing/switch 113 which may be, for example, a network switch or a router connected to a PSAP LAN/WAN ISP (internet service provider) circuit 111 such as, for example, one or more TI telecommunications lines, or the like, to provide Internet access to the ECC. The ingress/firewall 122, CPE routing/switch 123, ingress/firewall 112, PSAP routing/switch 113, ingress/firewall 132 and CAD routing/switch 133 may all be located within one or more equipment racks of ECC/PSAP. Depending on the size of the ECC, multiple APUs (i.e. ECC workstations) such as call handling PC 125, PSAP network PC 115, and CAD PC 135 may be present as the ECC front end 140. More than one of each type of ECC workstation may be present. The PSAP network PC 115 is operatively coupled to the ECC LAN (PSAP local network 110) and the Internet via the PSAP routing/switch 113, ingress firewall 112 and the PSAP LAN/WAN ISP circuit 111.

In some ECC/PSAP implementations, there may be separate APUs for call handling and CAD as shown in FIG. 1, or call handling and CAD software systems may be operating together on a single APU. Calls received by the ECC come into the ECC via the CPE circuit 121 and are internally switched or routed to the call handling PC 125 (i.e. an APU) as appropriate per the specific ECC call handling operational procedures implemented by the CPE routing/switch 123 and call handling server 124.

The term “call” as used herein comports with the NENA definition as “a generic term used to include any type of Request For Emergency Assistance (RFEA); and is not limited to voice.” Therefore, the term “call” may include a session established by signaling with two-way real-time media and involves a human making a request for help.” The terms “voice call”, “video call” or “text call” are used herein when the specific media is of significance. As per NENA definitions, the term “call” may refer to either a “voice call”, “video call”, “text call” or “data-only call”, since they are handled the same way through most of NG9-1-1.”

In the embodiment example shown in FIG. 1, a functional element of the CPE is operatively coupled to an interoperability apparatus 100. The interoperability apparatus 100 includes several connection ports such that the interoperability apparatus 100 is operative to connect to multiple functional elements. In some implementations, a port splitter may be employed, to enable a functional element to connect to multiple devices. In one example implementation of the FIG. 1 configuration, one or more functional element outputs may be connected to a port splitter (not shown) via a serial connection. Each serial connection to the interoperability apparatus 100 may be a DB 9 or DB 25 type connection, a USB connection, firewire connection, or the like, etc. A serial connection may be present between a port splitter and the interoperability apparatus 100 such that the serial connection provides a serial data input to the interoperability apparatus 100 from a CPE functional element. In some embodiments, the functional element may be ANI Controller. In another embodiment the functional element may be an ANI Controller that is integrated into a call handling functional element, such as call handling server 124. In yet another embodiment, the functional element may be an ANI modem bank that is operatively coupled to either a standalone ANI Controller or to an ANI Controller that is integrated into a call handling network 120 functional element. In any of these various implementations, the call handling server 124, the ANI Controller, whether standalone or integrated, and/or the ANI modem bank, may have a limited number of available serial ports. Therefore, a port splitter may be used when needed to accommodate providing one or more additional serial ports. Therefore, in some embodiments serial port splitters may not be required. The interoperability apparatus 100 is operative to receive ANI/ALI data 126 and CDR data 127 from the call handling server 124, or from any functional entities of the call handling network 120 that provide this data, whether via serial or via IP connectivity.

Another functional element of the CPE and call handling network 120 that may be operatively coupled to the interoperability apparatus 100, and that may be connected to a port splitter via a serial connection in some embodiments, is a functional element that receives AVL data 136 from an emergency responder vehicle fleet and that provides the AVL data 136 to the CAD network 130. In some embodiments, there may be two or more port splitters employed, for example, one port splitter connected to receive serial ANI/ALI data, and another port splitter connected to receive AVL data 136. In the example embodiment shown in FIG. 1, the interoperability apparatus 100 is operative to receive AVL data 136, and CAD incident data 137, from the CAD server 134, whether via serial or via IP connectivity.

The interoperability apparatus 100 includes serial-to-IP packet conversion capability such that it may convert received serial data to IP (Internet Protocol) packet data. The interoperability apparatus 100 may also include IP ports and be operative to receive IP connections from any ECC functional elements having IP connection capability. For example, in some embodiments, the interoperability apparatus 100 may have one or more Ethernet ports operative to connect to an IP device such as the PSAP routing/switch 113, the call handling server 124, and the CAD server 134.

In the case of ANI/ALI data 126, either a port splitter or an ANI Controller, Functional Element, provided by the call handling server 124 for example, etc., may directly, provide a serial connection for a serial data input to the interoperability apparatus 100 which is operative to receive serialized data and convert it to packetized data for transmission over the Internet. The serial connection may be a DB 9, a DB 25, or a USB connection. The interoperability apparatus 100 is operatively coupled to the PSAP routing/switch 113 via a connection which may be, for example an Ethernet cable. The PSAP routing/switch 113 provides access to the PSAP LAN/WAN ISP circuit 111 which is the backhaul connection to the Internet. In some embodiments, the interoperability apparatus 100 may connect to a functional entity, related to receiving ANI/ALI data, via an IP connection (i.e. such as via an Ethernet cable connection to an Ethernet port).

The interoperability apparatus 100 is also operatively coupled to the CPE routing/switch 113, or to the call handling server 124, to receive voice data 128. In some implementations, the interoperability apparatus 100 may be coupled to a SPAN (Switched Port Analyzer) port of the CPE routing/switch 113, or to the call handling server 124, in which the SPAN ports mirrors the voice data sent to the call handling PC 125. The interoperability apparatus 100 is operative to pass the voice data 128 to the EDMS 150 for processing. The EDMS 150 may perform voice recognition on the voice data 128 and search for key words, or certain combinations of key words, that serve as triggers for other operations of the EDMS 150, the interoperability apparatus 100 or both.

In one example of such operations, certain detected keywords may trigger CAD incident creation by the EDMS 150 using the interoperability apparatus 100. In one specific example of CAD incident creation, keywords such as “heart attack” may trigger creation of a CAD incident creation using a cardiac related incident form. Likewise, “burglary,” “robbery,” etc. may trigger creation of a CAD incident requiring a police response.

The EDMS 150 may also provide voice-to-text conversion or transcription services and may provide the voice transcripts to other functional entities of the ECC via the interoperability apparatus 100. In one example, the interoperability apparatus 100 may send voice-to-text transcripts, or portions thereof, from the EDMS 150 to the CAD server 134 for incorporation into CAD incident forms.

The voice data 128 may be voice data from trunked line calls or may be SIP (Session Initiation Protocol) calls using VoIP (voice-over-IP). The SIP state machine information (and also SS7 or C7 data from trunked calls) may also be passed to the interoperability apparatus 100 either as part of the voice data 128, or via a separate data connection from the CPE routing/switch 123 or from the call handling server 124, depending on which provides this data and where a SPAN port may be available. SIP data, SS7 or C7 data may be included in the CDR data 127 received by the interoperability apparatus 100 in some implementations. The SIP state machine data, and SS7 or C7 data, may, among other usages, be used by the EDMS 150 to provide logging and data analytics for the ECC, and the EDMS 150 may also perform incorporation of the SIP state machine data into CDRs. Likewise, SS7 or C7 data may also be incorporated into CDRs.

In some implementations, the EDMS 150 may include, or be interfaced with, a large language model (LLM) that is used to perform various analysis of the voice data 128 as transcribed by voice-to-text, or to perform or initiate certain operations or actions based on the LLM analysis of the received voice data 128.

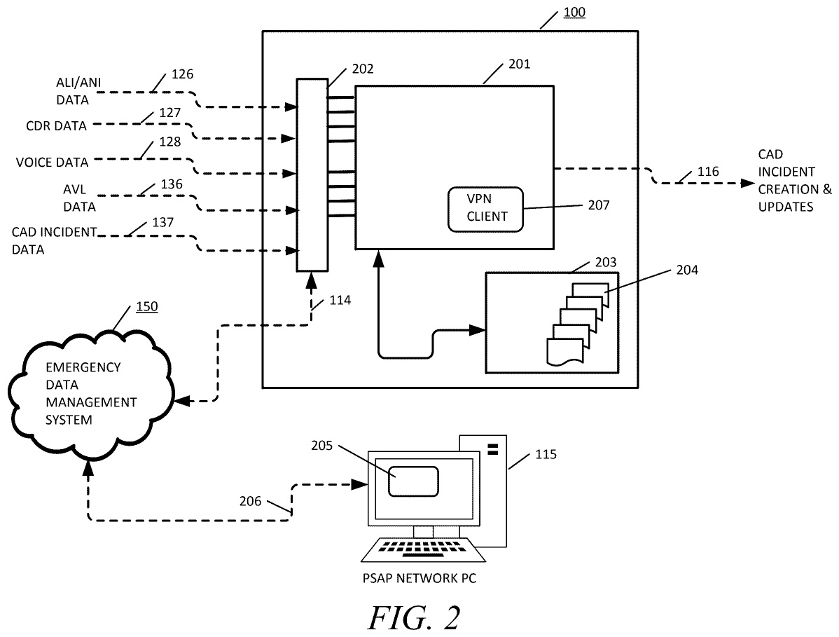

As shown in FIG. 2, the interoperability apparatus 100 includes at least one processor 201, and non-volatile, non-transitory memory 203 that is operatively coupled to the processor 201. The interoperability apparatus 100 includes various connection ports 202, both serial connection ports and IP connection ports, that are operatively connected to the processor 201. The interoperability apparatus 100 is operative to establish an IP connection 114 with the emergency data management system 150 (EDMS 150). In some embodiments, the memory 203 may include software (executable instructions or executable code) operative to implement a virtual private network (VPN) client (VPN client 207) and to establish a VPN connection between an ECC functional entity and the EDMS 105, over network and IP connections. For example, the interoperability apparatus may use a VPN connection to access the CAD network 130 which is a demilitarized zone (DMZ) network, also referred to as a screened network.

As shown in FIG. 2, the interoperability apparatus 100 is operative to receive ANI/ALI data 126, CDR data 127, voice data 128, AVL data 136 and CAD incident data 137 from the ECC. The interoperability apparatus 100 is operative to send all of this data to the EDMS 150 over the IP connection 114. In some embodiments, the non-volatile, non-transitory memory 203 stores various scripts 204 (i.e. executable code or executable instructions) that when executed by the processor 201, render the processor 201 operative to send and receive the various types of data and communicate with the various types of ECC functional entities. In some implementations, each data type may have a corresponding script 204 such that the interoperability apparatus 100 is easily upgradable or configurable to the specific needs of the ECC at which the interoperability apparatus 100 is installed. In some embodiments, the interoperability apparatus 100 is operative to include an ECC identifier to data it sends to the EDMS 150. The ECC identifier is a unique identifier that identifies a specific ECC. The ECC identifier, or components thereof, may be obtained partially or fully from the interoperability apparatus 100, or from any functional entity in the ECC, or may be another unique identifier unique to the ECC.

The EDMS 150 may utilize a cloud data endpoint which is an API endpoint and may be considered as the end of a communication channel between a functional entity, or the interoperability apparatus 100, and the EDMS 150. As mentioned above, a functional entity (or functional element) may be the call handling server 124, an ANI Controller, CAD server 134, etc. In that context, a cloud data endpoint may be considered an API (application programming interface) endpoint which enables the EDMS 150, via an interoperability apparatus 100, to communicate with the relevant functional entity. For example, a data endpoint, via an ANI/ALI API, may request resources from the interoperability apparatus 100 over the IP connection 114.

In some embodiments, an API at a data endpoint may be a RESTful API in which each ECC interoperability apparatus 100, from any of various ECCs, may represent an endpoint from which the cloud data endpoint can obtain data such as ANI/ALI data 126, CDR data 127, voice data 128, AVL data 136, CAD incident data 137, etc. The endpoint API therefore may define at least one URL endpoint with a domain, port, path, query string, or combination of these, etc., and within these definitions will be a unique ECC identifier.

The EDMS 150 is cloud-based, and may include one or more virtual servers, distributed servers, hardware servers, etc., and distributed non-volatile, non-transitory memory storage as required to provide a Saas (software-as-a-service) capability to the various ECCs such as a cloud-based application. The EDMS 150 provides each instance of the cloud-based application via a web portal graphical user interface (GUI), EDMS GUI 205, to one or more ECC workstations of multiple ECCs. As shown in the example of FIG. 2, the PSAP network PC 115 executes a web browser having an internet connection 206 to the EDMS 150 which provides the EDMS GUI 205 within the web browser. Each EDMS GUI 205 executed on an ECC workstation corresponds to an instance of the cloud-based application provided by the EDMS 150.

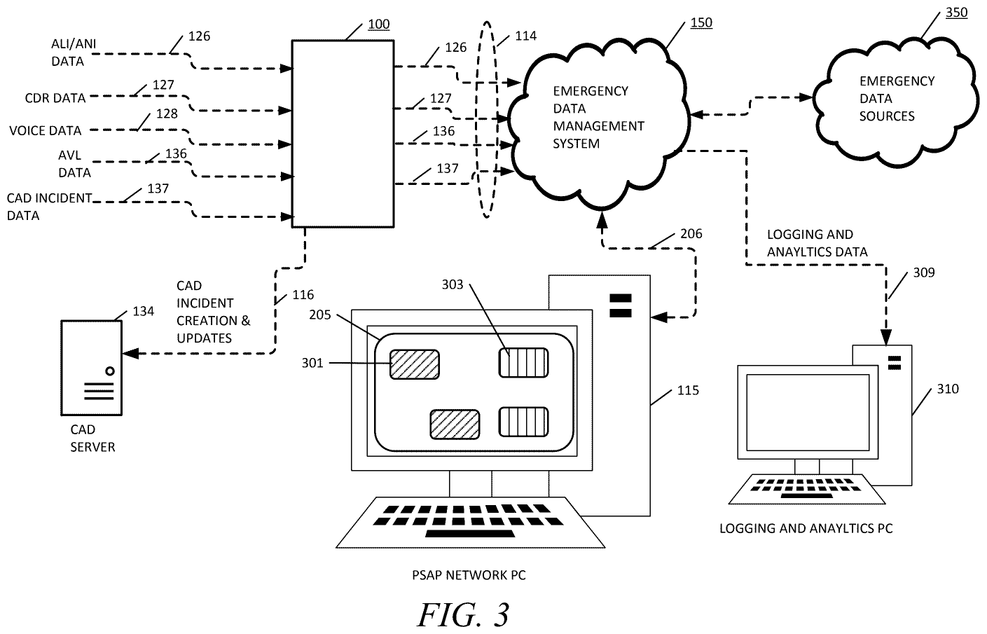

Turning to FIG. 3, an example interoperability apparatus 100 in communication with the EDMS 150 and provides data layers, logging and analytics data 309, and incident creation and updates 116 in accordance with an embodiment. The logging and analytics data 309 may be provided to a logging and analytics PC 310, or may be provided to a logging and analytics interface that is a part of the EDMS GUI 205. Among other features, the EDMS GUI 205 provides a map view with location indicators corresponding to emergency calls directed to the ECC (whether call routing is completed through the telephony network or not) and a call queue with ANI (caller ID) data for each call, in addition to other data such as ADR (additional data repository) data, medical data, etc. from the emergency data sources 350. The map view also includes emergency data, obtained by the interoperability apparatus 100 from an ECC functional entity, such as ANI/ALI data 126, and any pertinent data contained in CDR data 127 and AVL data 136. The data may be also be related to an ECC CAD incident form for given CAD incident types in CAD incident data 137. The interoperability apparatus is operative to provide CAD incident creation and update data 116 to the CAD server 134.

The EDMS 150 is operative to receive mobile device location data, and other emergency data, from various mobile location servers within emergency data sources 350. The EDMS 150 is also operative to receive emergency alerts from various emergency alert systems such as those described in U.S. Pat. No. 11,749,094 issued Sep. 5, 2023 to Pellegrini et al. Such emergency alerts may include, but are not limited to, home security alarms (which may include burglar alarms, fire alarms or other types of alarms), alarms for commercial buildings and institutions (which may also include burglar alarms, fire alarms, hazard alarms, etc.), medical bracelets, medical devices, etc. The mobile location servers receive hybrid location data from mobile devices via Internet connectivity to the mobile devices, and the data may include for example, but are not limited to, Android Mobile Location (AML) data, Android Emergency Location Service (ELS) data, and Hybridized Emergency Location (HELO) data provided by iOS™ devices, and other mobile device location data, etc. In some embodiments, the EDMS 150 uses the data from a cloud-based data endpoint to identify emergency location data and other data associated with device identifiers (i.e. ANI/ALI data) and can match up data from the cloud-based data endpoint with other available emergency data to provide more complete and accurate information to the ECCs. The match up of cloud-based data endpoint data with data received by the EDMS 150 enables identification of emergency calls that have been routed to the ECC via telephony routing. However, the EDMS 150 information is not limited to emergency calls that have been routed to the ECC via telephony routing and the data obtained from the mobile location servers, additional data servers, and emergency alerts systems can be obtained by the EDMS 150 and provided to the EDMS GUI 205 prior to the ECC receiving and answering the call.

Therefore, EDMS 150 is operative to provide an emergency call queue and a map view on the EDMS GUI 205 that shows location indicators for devices from which emergency calls have emanated even before completion of the emergency call routing to the ECC by the telephony network. The EDMS 150 is also operative to display emergency data on the map view. The emergency data may be, but is not limited to, ANI/ALI data 126, AVL data 136, CDR data 127, transcriptions of voice data 128, CAD incident data 137, etc. The ANI/ALI data 126 may be used by the EDMS 150 to distinguish calls that have already been received by (i.e. routed to) the ECC and provide more detailed and useable data. The ANI/ALI data 126 address, although often times not accurate and not used to actually dispatch emergency responders, may be used as incident identification information in CAD incident records created in the ECC CAD system.

Because either a cloud-based identification and authentication function, or the interoperability apparatus 100, adds an ECC identifier to data it receives, likewise the EDMS 150 identifies that data, using the ECC identifier to push related data for the specific ECC to an appropriate ECC workstation such as PSAP network PC 115 via the EDMS GUI 205.

The EDMS 150 may also determine which ECC should receive what data based on related mobile device location and whether a specific device that placed a call is located within an ECC geofence specified in a geofence database. The emergency call queue of the EDMS GUI 205 may be displayed in various distinct colors, font styles, or using distinctive icons such that the call takers understand each entry in the queue and can also distinguish between incoming calls and calls that have been placed but not yet received.

As the EDMS 150 detects calls arriving at the ECC via data it receives from the interoperability apparatus 100, or via the data it receives via the emergency data sources 350, the EDMS 150 can either change the call queue entry color, font style, or icon, etc. for queue entries related to calls that have been received by the ECC (or calls made but not yet routed or received at the ECC) such that the change appears on the EDMS GUI 205. For example, calls that have been received by the ECC will have data sent to the EDMS 150 from the interoperability apparatus 100.

In another implementation, the EDMS 150 can create a separate emergency call queue on the EDMS GUI 205 that is specific to the ECC workstation on which it is displayed. The specific emergency call queue can display, for example, only emergency calls related to device identifiers received by the specific workstation (i.e. based on an APU position number). The specific workstation, in some embodiments, may be identified within data received by the interoperability apparatus 100 such as the CDR data 127, or from other data received by a functional element of the call handling network 120.

Similarly, the map view provided by the EDMS GUI 205 may display location indicators for devices from which emergency calls have emanated before completion of the emergency call routing to the ECC differently than location indicators for emergency calls that have been received at the ECC. The EDMS GUI 205 may display location indicators in various distinct colors, using different font styles, or using distinctive icons such that the call takers understand each location point and can distinguish between incoming call locations and calls that have been placed from a location but not yet received at the ECC.

The map view provided by the EDMS GUI 205 may also display any of the data received by the interoperability apparatus (i.e. ANI/ALI data 126, CDR data 127, transcription of voice data 128, AVL data 136, and CAD incident data 137) using various distinct colors, using different font styles, or using distinctive icons, and within various layers (i.e. overlays on the display that can be toggled on and off). For example, different icons may be used for police, fire, medical, or other types of emergency responder vehicles. Different layers such as layer 301 and layer 303 may also be used to display specific data types. In one example, layer 301 may display AVL data 136. Therefore, location indicators and AVL indicators may be displayable in a layer format in which a user of the EDMS GUI 205 may turn layers on and off depending upon the operator's preferences or specific needs during handling a call or dispatch operations. The layer 303 may display CAD incident data 137 when layer 303 is toggled on. A layer for CDR data may also be available to the operator.

The EDMS GUI 205 may also provide an indication that additional data is available, such as data that may be important for a specific CAD incident type. The available data may be AVL data 136, ANI/ALI data 126, CDR data 127, transcription of voice data 128, CAD incident data 137 or a combination. The available data may be displayed within a popup window that displays when the workstation user hovers the mouse cursor over a location indicator or other indicator associated with an emergency call displayed on the map view. Some layered data may appear as a pop-up when a mouse cursor is hovered over a particular location indicator, when that specific data layer is toggled on. Some or all of the available data may be displayed within the call queue. In another alternative, the available data may be displayed in a separate popup window that displays when the workstation operator user selects an entry from the call queue.

The interoperability apparatus 100 may send data to the EDMS 150 in a streaming manner, or as a data push operation, as the data is obtained by the interoperability apparatus 100. In response to receiving data from the interoperability apparatus 100 whether sent in a data stream, as a push operation, or as a data query made via the EDMS GUI 205 by a call taker/operator, the EDMS 150 provides, or returns in response to a query, emergency data which includes, but is not limited to, augmented device location information and other additional data.

In some implementations, the CAD server 134 will include an integration enabling the CAD server 134 to query the EDMS 150 to obtain mobile location information. In that case, the mobile location information from the EDMS 150 is displayed within a data field of a CAD GUI in addition to the ANI/ALI data. The dispatcher accessing the CAD GUI can then use the mobile location information from the EDMS 150 to dispatch emergency responders to the correct location. Because the ANI/ALI data for mobile calls may include only cellular tower information for an incoming emergency call (i.e. a location associated with the cellular tower), the mobile location information from the EDMS 150 provides an accurate pinpointed location for the mobile device from which the emergency call was placed, providing an accurate location for dispatching emergency responders.

For handling data, the interoperability apparatus 100 may use RESTful API HTTP methods such as GET, POST, PUT, and DELETE. However, the interoperability apparatus 100 may use the POST method to send data to the EDMS 150 to create or update a resource at a cloud-based data endpoint. When the interoperability apparatus 100 sends a POST request to the cloud-based data endpoint, it will normally be accompanied by a payload of data that is used to create or update the resource on the data endpoint. In some embodiments, the data may be in the form of a JSON object. In some embodiment, the JSON object may be an EIDO (“Emergency Incident Data Object”). In some embodiments, the data may be in XML format. The interoperability apparatus 100 may also use the PUT method to update an existing resource on the data endpoint. For example, the data endpoint may send ANI/ALI updates via PUT when a mobile device in an emergency call changes locations, or for AVL data when an emergency responder vehicle changes location, etc. The EDMS 150 uses any of the RESTful API HTTP methods such as GET, POST, PUT, and DELETE to handle data with the interoperability apparatus 100, and also to provide data to the EDMS GUI 205 displayed on the PSAP network PC 115 or other device at the ECC.

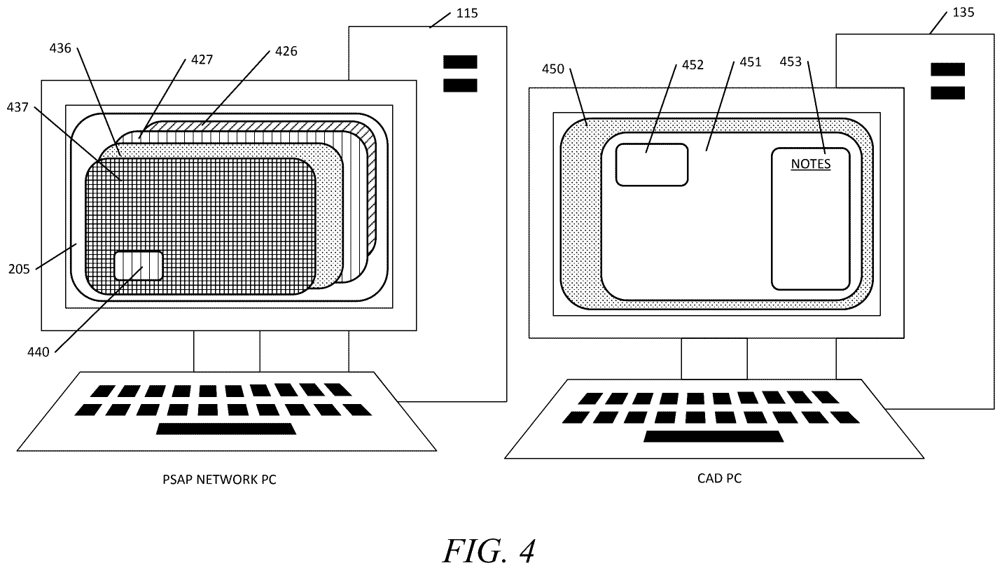

FIG. 4 provides diagrams of example graphical user interfaces (GUIs) provided to a computer system of a Public Safety Answering Point (PSAP), and to a computer-aided-dispatch (CAD) system of the PSAP in accordance with an embodiment. On the PSAP network PC 115, the EDMS GUI 205 is provided by the EDMS 150 via a web browser executing on the PSAP network PC 115. The EDMS 150 may provide the EDMS GUI 205 with various data layers that may be toggled on and off according to the user's preferences. For example, the EDMS GUI 205 may include an AVL data layer 436, an ANI/ALI data layer 426, a CDR data layer 427, a CAD incident data layer 437 or a combination. A layer showing transcription of voice data may also be present. In various implementations, a pop-up window such as pop-up window 440 may be activated by enabling a specific layer such that hovering a mouse cursor over a given part of the EDMS GUI 205 causes display of the pop-up window 440 having data associated with the specific layer. The data associated with each layer is obtained by the interoperability apparatus 100 and sent to the EDMS 150, which in turn processes the data as necessary so as to display it within the EDMS GUI 205.

On the CAD PC 135, CAD software provides a CAD GUI 450 and may display a CAD incident form 451 which includes data specific to an incoming emergency call being handled. The CAD incident form 451 includes, among other data fields, an ANI/ALI field 452 and a notes field 453. The EDMS 150, via the interoperability apparatus 100 may populate a CAD incident form 451, or may update it from time-to-time with supplemental data such as location updates and data from the emergency data sources 350. In some situations, where specific data does not correspond to the specific data field of the CAD incident form 451, or is too large an amount of data, the EDMS 150 may populate the notes field 453 with the additional data. In some implementations, the ANI/ALI field 452 may be enhanced with mobile device location data obtained by the EDMS 150.

In the example implementation of FIG. 4, the interoperability apparatus 100, in some embodiments, may use a VPN to communicate with the CAD network 130 when the CAD network 130 is a screened subnet, which also may be referred to as a demilitarized zone (DMZ). In that case, the screened subnet may include the CAD system which further includes the CAD server 134, one or more CAD workstations such as CAD PC 135, and at least one DMZ network device which may be an internal router such as a choke router. In some ECC implementations, the CAD PC 135 may access to a CAD application provided by the CAD server 134. In that case, the CAD PC 135 may have restricted access to external websites and may be restricted to functions provided by the CAD server 134 with few exceptions.

In some implementations, the CAD PC 135 may be enabled to access the EDMS 150 to display the EDMS GUI 205. However, in some ECC implementations, only the PSAP network PC 115, which is isolated from the screened subnet, may access the EDMS GUI 205. As discussed above, the CAD PC 135 displays a CAD GUI 450 which may access a CAD application provided by the CAD server 134 in the DMZ. The CAD operator uses a CAD incident form 451 provided by the CAD GUI 450, to input CAD incident information. Each CAD incident type will have a corresponding CAD incident form 451 that may also correspond to an incident type having an incident type code as described in the APCO International standard discussed above. In accordance with the embodiments, the interoperability apparatus 100 is operative to establish a connection to the CAD screened subnet to send data from the EDMS 150 to the CAD server 134.

The EDMS 150 may utilize an ECC script specific to the ECC being served as discussed with respect to FIG. 2. The ECC script, when executed, is operative to receive EDMS emergency alerts data received by the EDMS 150 from emergency alerts systems and provide the output data in a format for use by a CAD incident creation subprocess. In some embodiments, the EDMS 150 may also insert additional data into the emergency alert data received from the emergency alerts systems, prior to the ECC script at the EDMS 150 processing it and sending it to the ECC as output data.

In one example, the EDMS 150 may receive emergency alerts data from emergency alerts systems, where the emergency alerts data corresponds to emergency alerts generated and provided by systems, apparatuses and methods such as those described in U.S. Pat. No. 11,749,094 issued Sep. 5, 2023 to Pellegrini et al. The EDMS 150 may select an appropriate class of service for sending this data to the ECC. Class of service refers to a designation of the type of telephone service, for example, residential, business, PBX, wireless, VOIP, etc. Examples and recommended classes of service (CoS) are provided in “NENA Standard Data Formats For E9-1-1 Data Exchange & GIS Mapping,” NENA-STA-015.10-2018. Examples of the NENA recommended classes of service include, but are not limited to, residence, business, mobile, various voice-over-IP (VOIP) classes of service such as VOIP Residence, VOIP Business, etc.

Incoming ANI/ALI data received by an ECC contains class of service (CoS) information related to each incoming emergency call. The EDMS 150 is operative to identity each data field for all of the possible CoS that may be received by an ECC. In one embodiment, the EDMS 150 is operative to format incoming emergency alert data according to a CoS determined to have the largest number of data fields. Because all of the possible CoS are recognizable by the CAD incident creation subprocess, the output data can be sent to the CAD server 134 and will be recognized by the CAD incident creation subprocess and displayed in the CAD GUI 450 as an incoming emergency call for the given CoS. The CAD system operator can then proceed to utilize an appropriate CAD incident form 451 using the output data. In one specific example embodiment, the CoS having the largest number of data fields may be a VoIP (voice-over-Internet-Protocol) CoS and emergency alerts may be formatted according to a VoIP CoS for incident creation and updates 116. Specifically for CAD incident updates, the data sent to the CAD server 134 will include the ANI/ALI address which is used by the CAD server 134 to identify the appropriate existing CAD incident form 451 to be updated.

For newly created CAD incidents, based on the information contained in the output data displayed to the CAD operator, the CAD operator may select an appropriate CAD incident type and CAD incident type code by assessing the output data as emergency data associated with an emergency call. The EDMS 150, and cloud-based application, are operative to receive emergency alerts data from the emergency alerts systems, and send it to the interoperability apparatus 100. In turn, the interoperability apparatus 100 is operative to send the output data to the CAD server 134 over a TCP connection. The output data is then used to populate the relevant CAD incident form 451, ANI/ALI field 452, and notes field 453 as required.

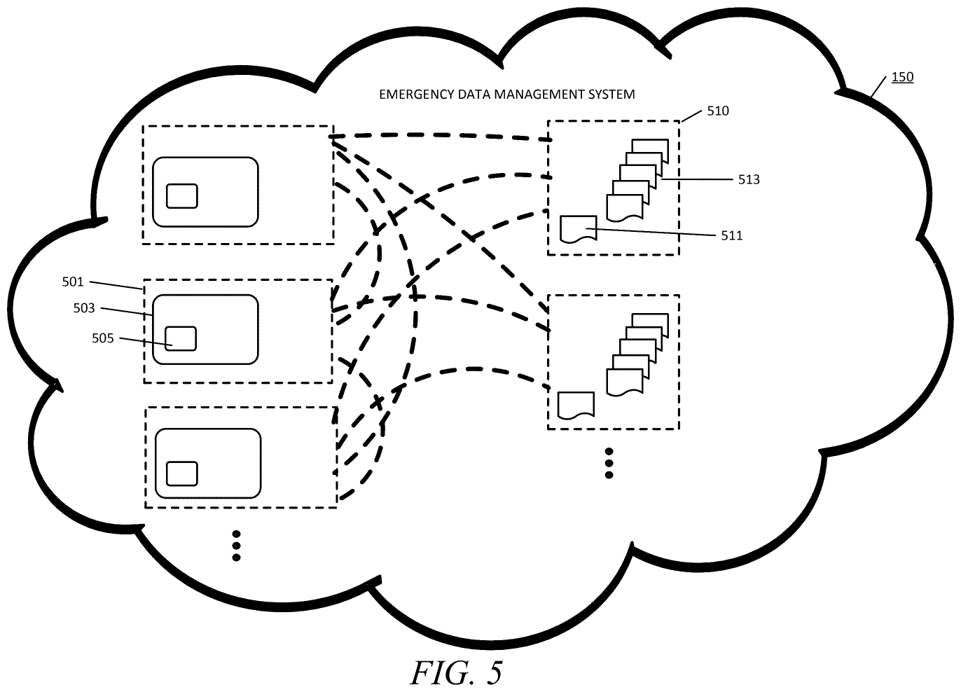

FIG. 5 is a block diagram showing further details of the EDMS 150 in accordance with various embodiments. The EDMS 150 includes a number of cloud servers 501, with each cloud server including at least one processor 503 operative to execute the cloud-based application 505. The EDMS 150 also includes a number of non-volatile, non-transitory memory 510 that store executable instructions (code) 511 for the cloud-based application 505. The memory 510 may also store numerous scripts 513, which are also executable instructions, for data operations including, but not limited to, data format conversions for the various types of data received by the EDMS 150. This data received by the EDMS 150 includes, but is not limited to, ANI/ALI data, CDR data, voice data, AVL data, CAD incident data, mobile device hybrid locations data, additional data repository (ADR) data, alarm data, and the like, etc. The scripts 513 may include scripts that are tailored for specific ECCs in order to meet the specific ECCs detailed requirements for data handling and data presentation, etc. The ECC detailed requirements include, but are not limited to, the specific types of data handled for that ECC and the specific data fields included in those data types for that ECC. The scripts 513 may be executed by the EDMS 150 on the cloud servers 501 as needed when specific types of data are received and for specific ECCs, etc. The interoperability device 100 located at each ECC is operative to receive data processed by the scripts 513 and send the data accordingly, as needed, to specific functional elements within the ECC such as the CAD server, etc. The EDMS 150 is operative to send data to the cloud-application 505 instance at each ECC accordingly as needed to update the EDMS GUI 205 for each cloud-application 505 instance executing at each ECC.

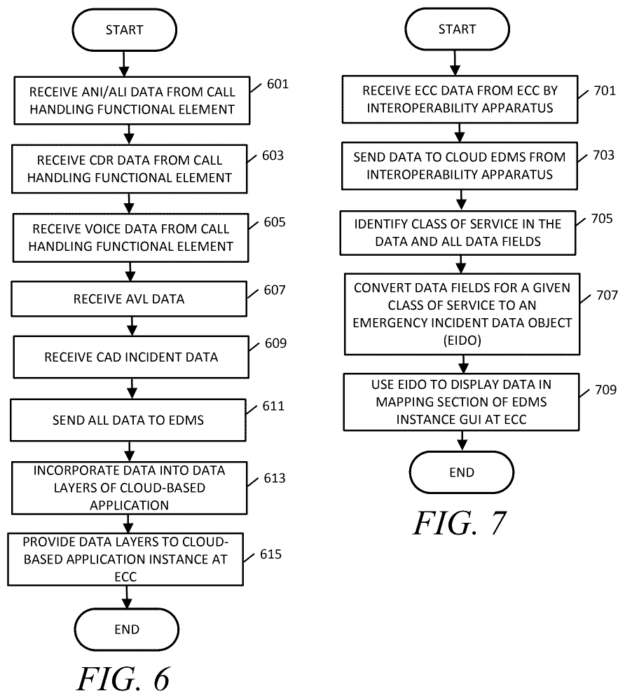

FIG. 6 is a is a flowchart of a method of operation of an interoperability apparatus in accordance with an embodiment. At operation 601 the interoperability apparatus 100 receives ANI/ALI data from a functional element of the call handling network 120. The functional element may be an ANI/ALI modem, the CPE routing/switch 123, the call handling server 124, or the like, etc. At operation 603 the interoperability apparatus 100 receives CDR data from a functional element of the call handling network 120. At operation 605 the interoperability apparatus 100 receives voice data from a functional element of the call handling network 120. At operation 607 the interoperability apparatus 100 receives AVL data from a functional element of the ECC which may be within the call handling network 120 or the CAD network 130. At operation 609 the interoperability apparatus 100 receives CAD incident data from the CAD server 134. At operation 611 the interoperability apparatus 100 sends the received data to the EDMS 150. The data may be sent by the interoperability apparatus 100 as it is received, in a packetized format, a streaming format, using a PUSH operation or the like, etc. At operation 613 the the EDMS 150 incorporates the received data into data layers for that ECC within the cloud-based application. At operation 615 the EDMS 150 provides the data layers to the cloud-based application instance at the ECC.

FIG. 7 is a is a flowchart of a method of operation of an EDMS in accordance with an embodiment. At operation 701 the interoperability apparatus 100 receives ECC data from the ECC from various functional elements within the call handling network 120, CAD network 130, PSAP local network 110, etc. At operation 703 the interoperability apparatus 100 send the ECC data to the EDMS 150 over an internet connection. At operation 705 the EDMS 150 identifies a class of service (CoS) and relevant data fields in any of the data it has received. At operation 707 the EDMS 150 converts the data fields in an emergency incident data object (EIDO) and at operation 709 uses the EIDO to display the data in a mapping section (or other sections) of the cloud-based application instance at the ECC via the EDMS GUI 205.

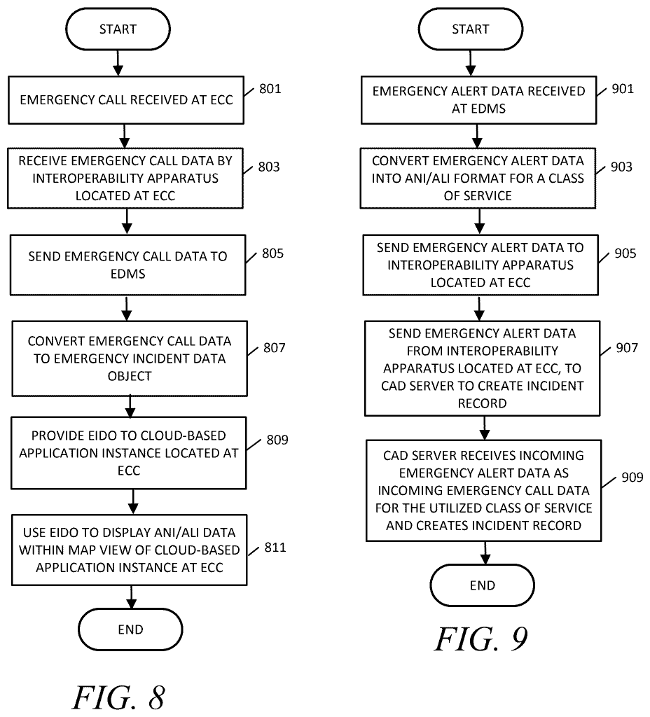

FIG. 8 is a is a flowchart of a method of operation of an interoperability apparatus and EDMS in accordance with an embodiment. At operation 801 an emergency call is received at the ECC which means it has begun to be processed within the call handling network 130. At operation 803 the interoperability apparatus 100 receives related emergency call data from the various functional elements. At operation 805 the interoperability apparatus 100 sends the emergency call data to the EDMS 150. At operation 807 the EDMS 150 converts the emergency call data into EIDO format and at operation 809, provides the EIDO to the cloud-based application instance at the ECC. At operation 811 the EIDO is used to display ANI/ALI data within a map view, or other sections, of the cloud-based application instance via the EDMS GUI 205.

FIG. 9 is a is a flowchart of a method of operation of an interoperability apparatus and EDMS in accordance with an embodiment. At operation 901 the EDMS 150 receives emergency alert data from the emergency data sources 350. Such emergency alerts may include, but are not limited to, home security alarms such as burglar alarms, fire alarms, carbon monoxide alarms, or other types of alarms, alarms for commercial buildings and institutions (which may also include burglar alarms, fire alarms, hazard alarms, etc.), medical bracelets, medical devices, etc. At operation 903 the EDMS 150 converts the alarm data into an ANI/ALI format for a CoS. At operation 905 the EDMS 150 sends the formatted emergency alert data to the interoperability apparatus 100 at the ECC. At operation 907 the interoperability apparatus 100 sends the formatted emergency alert data to the CAD server to create an incident record. The interoperability apparatus 100 may send the data in a serial format, using a TCP connection, or a combination of these and may also utilize a VPN connection in some implementations. At operation 909 the CAD server 134 receives the emergency alert data and creates a CAD incident record.

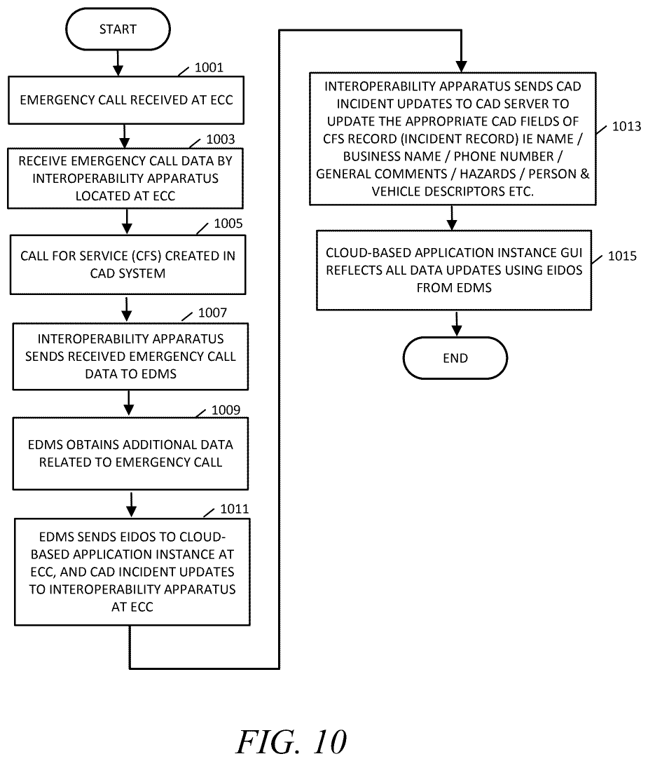

FIG. 10 is a flowchart of a method of operation of an interoperability apparatus and EDMS in accordance with an embodiment. At operation 1001 an emergency call is received at the ECC which means it has begun to be processed within the call handling network 130. At operation 1003 the interoperability apparatus 100 receives related emergency call data from the various functional elements. At operation 1005 a CFS is created in the CAD system and a CAD incident form 451 is utilized. At operation 1007 the interoperability apparatus 100 sends the received related emergency call data to the EDMS 150. At operation 1009 the EDMS 150 obtains additional data related to the emergency call. The additional data includes data obtained from the emergency data sources 350, such as, but not limited to, ADR data, mobile device hybrid location data, medical data, and the like, etc. At operation 1011 the EDMS 150 sends EIDOs to the cloud-based application instance (or instances) at the ECC and also sends CAD incident updates to the CAD server 134 via the interoperability apparatus 100. At operation 1013 the interoperability apparatus 100 sends the CAD incident updates, which may be more than one update and may be sent from time-to-time as the EDMS 150 receives further additional data. At operation 1015 the cloud-based application instance reflects data updates using the EIDOs from the EDMS 150 and the EDMS GUI 450 is able to display the updates.

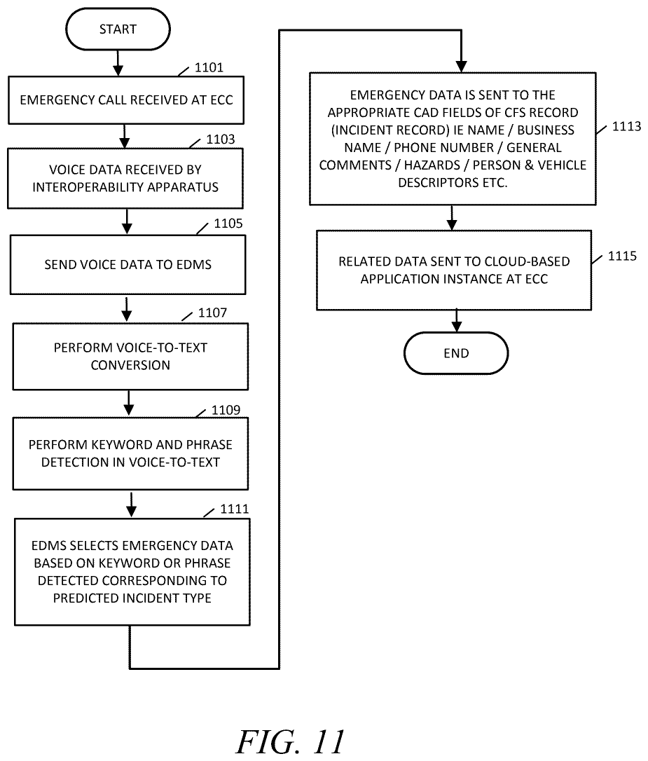

FIG. 11 is a flowchart of a method of operation of an interoperability apparatus and EDMS in accordance with an embodiment.

At operation 1101 an emergency call is received at the ECC which means it has begun to be processed within the call handling network 130. At operation 1103 voice data 128 is received by the interoperability apparatus 100 from a functional element of the call handling network 120. At operation 1105 the interoperability apparatus 100 sends the voice data 128 to the EDMS 150. The voice data 128 may be sent as digital voice data contained in data packets. In some embodiments, the voice data 128 may be send as streaming audio. At operation 1107 the EDMS 150 performs voice-to-text conversion. In some embodiments, voice-to-text conversion may be performed by the interoperability apparatus 100. At operation 1109 the EDMS 150 performs keyword and phrase detection in the voice-to-text data. At operation 1111 the EDMS 150 selects emergency data based on the keyword or phrase detected corresponding to an incident type. The incident type may be predicted by the EDMS 150 based on the detected keywords and phrases. At operation 1113 the selected emergency data is sent to the CAD server 134 using the interoperability apparatus 100 to input to the appropriate CAD data fields of a CAD incident record. At operation 1115 the related data is also sent to the cloud-based application instance at the ECC for display within the EDMS GUI 205.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A method comprising:
obtaining emergency data related to an emergency call to an emergency communication center (ECC) by an interoperability apparatus operatively coupled to a plurality of functional elements of the ECC;
sending the emergency data from the interoperability apparatus to a cloud-based emergency data management system;
converting a portion of the emergency data into a data object at the cloud-based emergency data management system;
providing the data object to an instance of a cloud-based application provided by the cloud-based emergency data management system, the instance executed using a browser on a computer located at the ECC, the data object updating a map view within a graphical user interface provided by the instance; and
providing update data from the cloud-based emergency data management system to a computer-aided-dispatch system using the interoperability apparatus.

2. The method of claim 1, wherein obtaining emergency data, comprises:
obtaining ANI/ALI (Automatic Number Identification/Automatic Location Identification) data, call detail record (CDR) data, and AVL (Automatic Vehicle Location) data from at least one functional element of the ECC, by the interoperability apparatus.

3. The method of claim 1, wherein obtaining emergency data, comprises:
obtaining voice data from a functional element of the ECC, by the interoperability apparatus.

4. The method of claim 1, wherein obtaining emergency data, comprises:
obtaining serial text data via a serial port connection between the interoperability apparatus and the functional element.

5. The method of claim 1, wherein obtaining emergency data, comprises:
obtaining packetized data via a network connection between the interoperability apparatus and the functional element.

6. The method of claim 1, wherein obtaining emergency data, comprises:
obtaining call handling data from the functional element by the interoperability apparatus.

7. The method of claim 1, wherein converting a portion of the emergency data into a data object, comprises:
converting the portion of the emergency data into a javascript object notation (JSON) data object.

8. The method of claim 1, wherein converting a portion of the emergency data into a data object, comprises:
converting the portion of the emergency data into an emergency incident data object (EIDO).

9. The method of claim 1, wherein converting a portion of the emergency data into a data object, comprises:
converting the portion of the emergency data into a customized emergency incident data object (EIDO), customized based on requirements of the ECC.

10. A system comprising:
a interoperability apparatus, comprising at least one processor and a non-volatile, non-transitory memory, operatively coupled to the at least one processor, the interoperability apparatus located at an emergency communication center (ECC), operatively coupled to an ECC functional element, and a cloud-based emergency data management system comprising at least one cloud server and operatively coupled non-volatile, non-transitory memory, the interoperability apparatus operative to receive emergency call data from a plurality of ECC functional elements and from an ECC computer-aided-dispatch (CAD) system; and
the cloud-based emergency data management system operative to:
receive the emergency call data from the interoperability apparatus;
convert the emergency call data into a data object;
send the data object to an instance of a cloud-based application executed by a computer located at the ECC; and
update a map view of the instance of the cloud-based application using the data object.

11. The system of claim 10, wherein the interoperability apparatus is further operative to:
obtain ANI/ALI (Automatic Number Identification/Automatic Location Identification) data, call detail record (CDR) data, and AVL (Automatic Vehicle Location) data from at least one functional element of the ECC, by the interoperability apparatus.

12. The system of claim 10, wherein the interoperability apparatus is further operative to:
obtain voice data from at least one functional element of the ECC, by the interoperability apparatus.

13. The system of claim 10, wherein the interoperability apparatus is further operative to:
obtain serial text data via a serial port connection between the interoperability apparatus and the functional element.

14. The system of claim 10, wherein the interoperability apparatus is further operative to:
obtain packetized data via a network connection between the interoperability apparatus and the functional element.

15. The system of claim 10, wherein the interoperability apparatus is further operative to:
obtain call handling data from the functional element by the interoperability apparatus.

16. The system of claim 10, wherein the cloud-based emergency data management system is further operative to:
convert the emergency data into a javascript object notation (JSON) data object.

17. The system of claim 10, wherein the cloud-based emergency data management system is further operative to:
convert the emergency data into an emergency incident data object (EIDO).

18. The system of claim 10, wherein the cloud-based emergency data management system is further operative to:
convert the emergency data into a customized emergency incident data object (EIDO), customized based on requirements of the ECC.

19. A method comprising:
obtaining voice data related to an emergency call to an emergency communication center (ECC) by an interoperability apparatus operatively coupled to a functional element of the ECC;
sending the voice data from the interoperability apparatus to a cloud-based emergency data management system;
performing keyword analysis of the voice data by the cloud-based emergency data management system; and
providing a data object to an instance of a cloud-based application provided by the cloud-based emergency data management system, the instance executed using a browser on a computer located at the ECC, the data object updating a map view within a graphical user interface provided by the instance with additional data in response to the keyword analysis.

20. A method comprising:
obtaining voice data related to an emergency call to an emergency communication center (ECC) by an interoperability apparatus operatively coupled to a functional element of the ECC;
sending the voice data from the interoperability apparatus to a cloud-based emergency data management system;
performing keyword analysis of the voice data by the cloud-based emergency data management system;
providing update data from the cloud-based emergency data management system to a computer-aided-dispatch (CAD) system using the interoperability apparatus, in response to the keyword analysis.

21. The method of claim 20, further comprising:
updating a CAD incident form in response to the keyword analysis.
